(19) United States
(12) Patent Application Publication
(10) Pub. No.: US 2014/0308919 A1
(43) Pub. Date: Oct. 16, 2014

(54) APPLICATION-LEVEL TRUSTED THIRD PARTY SOLUTION BASED ON AN ANTIVIRAL MOBILE CLIENT

(71) Applicant: RAWLLIN INTERNATIONAL INC., Tortola (VG)

(72) Inventor: Dmitry Baranov, Saint Petersburg (RU)

(73) Assignee: Rawllin International Inc., Tortola (VG)

(21) Appl. No.: 13/860,622

(22) Filed: Apr. 11, 2013

(51) Int. Cl. H04W 12/10

(52) U.S. Cl. CPC H04W 12/10
USPC 455/410

(57) ABSTRACT

An application-level trusted third party solution is provided based on an antiviral mobile client. The system can receive, from an application executing on a mobile device, requests to perform functions controlled by an operating system executing on the mobile device, and send status requests to an antiviral application executing on the mobile device in response to receiving the requests. The system can also receive antiviral status reports associated with the mobile device in response to sending the status request to the antiviral application, and thereafter can forward the antiviral status report to the application, wherein the antiviral status report is employed by the application to perform the functions on the mobile device.

### TECHNICAL FIELD

The subject disclosure relates generally to an application-level trusted third party solution based on an antiviral mobile client.

### BACKGROUND

Every application operational and/or under the control of a mobile operating system (OS) executing on a mobile device can be at risk of unauthorized privilege level access to its functions and data unless jailbreaking (e.g., providing root access to an operating system) detection measures have been implemented. Implementation of jailbreaking detection measures within applications operational or executing on mobile devices nevertheless can be costly and does not necessarily provide a satisfactory level of assurance as many mobile device vendors intentionally or unwittingly provide facilities to access the underlying operating system.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

This disclosure describes a system that can comprise: a memory to store instructions, and a processor, communicatively coupled to the memory, which facilitates execution of the instructions to perform operations. The operations can include receiving, from an application that is executing on a mobile device, a request to perform a function controlled by an operating system executing on the mobile device, and sending a status request to an antiviral application executing on the mobile device in response to receiving the request. Additionally, the operations can also include receiving an antiviral status report associated with the mobile device in response to sending the status request to the antiviral application, and forwarding the antiviral status report to the application, wherein the antiviral status report is employed by the application to perform the function on the mobile device. In this regard, the antiviral status report either grants the application permission to perform the function on the mobile device, or denies the application permission to perform the function on the mobile device. Further, the functions controlled by the operating system include: a grant for access to a protected kernel resource associated with the operating system, a grant for access to a data resource remotely accessed via a communication port controlled by the operating system, and/or a request by the application for a further or continued operation. Additionally, the system, in response to failing to obtain the antiviral status report within a defined duration of time, notifies the application to perform the function and records an entry into a transactional log noting performance of the function by the application.

### BRIEF DESCRIPTION OF THE DRAWINGS

FIG. 1 provides a non-limiting depiction of a system that receives a request to perform an action, function, or operation from an application executing on the system in accordance with described aspects.

FIG. 2 provides a further non-limiting illustration of a system that receives a request to perform an action, function, or operation from an application executing on the system in accordance with described aspects.

FIG. 3 provides another non-limiting illustration of a system that receives a request to perform an action, function, or operation from an application executing on the system in accordance with described aspects.

FIG. 4 provides yet a further non-limiting illustration of a system that receives a request to perform an action, function, or operation from an application executing on the system in accordance with described aspects.

FIG. 5 provides a non-limiting depiction of an application that has sufficient capability to conduct interactions with an antiviral component without the necessity for an intermediary component to intercept calls or requests to ensure the system is not compromised.

FIG. 6 illustrates an example methodology that can be utilized by an application operational or executing on a system.

FIG. 7 illustrates an example methodology functional on an intermediary or interception component that can intercept calls for resources from an application operational on a system in accordance with described aspects.

FIG. 8 illustrates further example method that can be operational or executing on antivirus component in accordance with various aspects described herein.

FIG. 9 illustrates a block diagram of an example electronic computing environment that can be implemented in conjunction with one or more aspects.

FIG. 10 illustrates a block diagram of an example data communication network that can be operable in conjunction with various aspects described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the disclosure, as generally described herein, and illustrated in the Figures, can be arranged, substituted, combined, separated, and designed in a wide variety of different configurations, all of which are explicitly contemplated herein.

As noted above, every application operational or executing within a mobile operating system can be under risk of unauthorized privilege-level attack (e.g., by hacking using Trojan applications or other malware) to its functions and data unless host device jail breaking detection measures have been implemented. Implementing such detection measures within applications operational and/or executing on a mobile device can be extremely costly. Additionally, implementation of jail breaking detection measures does not necessarily ensure any degree of assurance, as many device vendors intentionally provide jail breaking methodologies to facilitate access to their mobile devices. Moreover, where applications attempt to utilize undocumented system mechanisms to detect a mobile system's properties, these actions can be perceived as being requests for unauthorized access to resources and/or data, which will more often than not be denied.

In accordance with the foregoing therefore, the various embodiments set forth in this disclosure can include a system comprising a memory to store instructions or computer executable instructions, and a processor coupled to the memory. The processor can facilitate execution of the stored computer executable instructions to perform operations. The operations can include receiving, from an application that can be executing or operating on a mobile device, a request to perform a function controlled by an operating system that is operational or executing on the mobile device. Additionally, the operations can also include sending a status report to an antiviral application or component that is also executing or operational on a mobile device in response to receiving the request from the application. Further, the operations can also include receiving an antiviral status report associated with the mobile device, and thereafter forwarding the antiviral status report to the application, at which point the antiviral status report can be employed by the application to perform the function on the mobile device.

Additionally and/or alternatively, the subject disclosure can include a system comprising a memory to store instructions and a processor coupled to the memory. The processor can facilitate the execution of the stored instructions which when executed can perform operations. These operations can include, receiving, from a calling component, a request to perform an operation on a mobile device by the calling component. Further, the operations can include, in response to the request, generating and sending a status request to an antiviral component, in response to sending the status request to the antiviral component, receiving a status report, and as a function of the status report returned from the antiviral component, dispatching a permission notification to the calling component to perform the operation on the mobile device.

Further, in accordance with further embodiments, the subject disclosure describes a method, wherein the method comprises, in response to receiving a request to perform an operation controlled by an operating system executing on a mobile device, sending a status request to an antiviral application or component executing on the mobile device, and as a function of receiving a status report from the antiviral application or component in response to the status request, performing the operation on the mobile device.

Further, this disclosure describes a tangible computer readable medium or storage medium that can comprise instructions. The instructions, in response to execution, can cause a computing system that includes a processor to perform operations. The operations can include receiving a status report from a control component in response to directing a status request to the control component, and forwarding the status report to an activation component that performs an action on a mobile device as a function of the status request.

In accordance with yet further aspects the disclosure describes a system that can comprise a memory to store instructions, and a processor, communicatively coupled to the memory, that facilitates execution of the instructions to perform operations. The operations can include receiving, from an application that is executing on a mobile device, a request to perform a function controlled by an operating system executing on the mobile device, and sending a status request to an antiviral application executing on the mobile device in response to receiving the request. Additionally, the operations can also include receiving an antiviral status report associated with the mobile device in response to sending the status request to the antiviral application, and forwarding the antiviral status report to the application, wherein the antiviral status report is employed by the application to perform the function on the mobile device. In this regard, the antiviral status report either grants the application permission to perform the function on the mobile device, or denies the application permission to perform the function on the mobile device. Further, the functions controlled by the operating system include: a grant for access to a protected kernel resource associated with the operating system, a grant for access to a data resource remotely accessed via a communication port controlled by the operating system, and/or a request by the application for a further or continued operation. Additionally, the system, in response to failing to obtain the antiviral status report within a defined duration of time, notifies the application to perform the function and records an entry into a transactional log noting performance of the function by the application.

In accordance with still further aspects the disclosure describes a method that can comprise, in response to receiving a request to perform an operation from an application under control of an operating system executing on a mobile device, sending a status request to an antiviral application executing on the mobile device, and as a function of receiving a status report within a defined period of time from the antiviral application in response to the status request, notifying the application of a permission to perform the operation on the mobile device. The method can also include: accessing a data resource located remotely from the mobile device as a function of the permission; accessing a kernel operation associated with the operating system as a function of the permission; and directing a request for data to a database via a communication port controlled by the operating system as a function of the permission. In regard to the foregoing, in response to failing to receive the status report within the defined period of time, the method can perform operation to: notify the application to perform the operation and to record an entry into a log that identifies the application as having performed the operation; notify the application to desist from performing the operation and to record an entry into a log that identifies the application as having desisted performance of the operation; notify the application to enter a sleep state for a defined back off period prior to resending the request on an expiration of the defined back off period; and/or notify the application to cease operations and to record a failure to perform the operation in a log entry.

In accordance with yet other aspects, the disclosure describes a tangible computer readable medium comprising instructions that, in response to execution, cause a computing system including a processor to perform operations. The operations can include receiving a status report from a control component within a defined time period in response to directing a status request, by an activation component, to the control component, and forwarding the status report to the activation component that thereafter performs an action on a mobile device as a function of the status report. The tangible computer readable medium can further comprise operation for: in response to not receiving the status report within the defined time period, forwarding a permission to the activation component to perform the action on the mobile device and to record indication of the forwarding of the permission to a transactional log; in response to not receiving the status report within the defined time period, forwarding a request that the activation component enter a state of stasis for a randomly selected time period before redirecting the status request to the control component at an expiration of the randomly selected time period; and as a function of not receiving the status report within the defined time period, forwarding a cease operations request to the activation component. Additionally, tangible computer readable medium can include operations for a successful completion of the action on the mobile device notifying a remotely situated antivirus update server of the successful completion of the action.

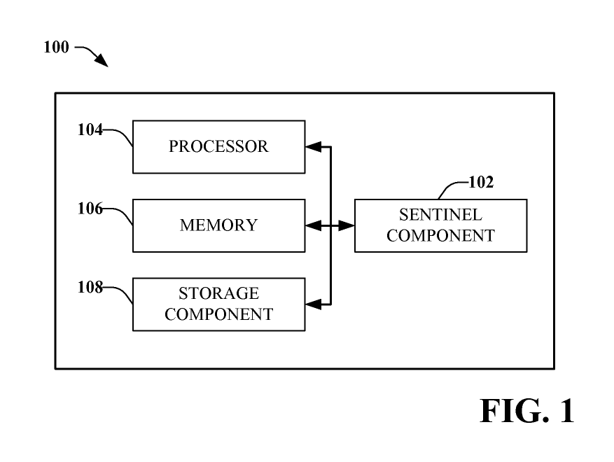

Turning now to the diagrams, FIG. 1 provides a non-limiting depiction of a system 100 (e.g., a mobile device, cellular device, mobile handset, user equipment . . . ) that receives a request to perform an action, function, or operation on the mobile device (e.g., system 100) from an application executing on the mobile device (e.g., system 100). Additionally and/or alternatively, system 100 can also receive requests from applications operational or executing on system 100 necessitating system 100 to perform actions, functions, or operations that are external to system 100 (e.g., access databases situated in the cloud, access databases communicatively coupled to system 100, utilize peripheral devices such as printers (inclusive of 3D printers), scanners, facsimile machines, multifunctional peripherals (MFPs), etc.). Typically, the actions, functions, and/or operations that are performed are ones that can be controlled by an operating system (or aspects thereof) operational on or executing on a mobile device.

On receipt of the request to perform an action, function, or operation on the mobile device, system 100 can send a status request to an antiviral application or component that can also be operational or executing on the mobile device (e.g., system 100). The antiviral application or component, in response to receiving the status request, responds with an antiviral status report which can be utilized by the application to perform or initiate the action, function, or operation on the mobile device.

In an additional and/or alternative embodiment, in response to receipt of a request to perform an action, function, or operation controlled by an operating system executing on a mobile device, system 100 can send a status request to an antiviral application or component executing on the mobile device, and as a function of receiving a status report back from the antiviral application or component in response to the status request, can perform the action, function, or operation on the mobile device (e.g., system 100).

In yet a further additional and/or alternative embodiment, system 100 can receive a status report from a control component in response to directing a status request to the control component, and forward the status report to an activation component that can perform one or more action, function, or operation on the mobile device as a function of the status report.

Aspects of the systems, apparatuses, or processes explained in this disclosure can constitute machine-executable components embodied within machines, e.g., embodied in one or more computer readable mediums (or media) associated with one or more machines. Such components, when executed by the one or more machines, e.g., computers, computing devices, virtual machines, etc. can cause the machines to perform the operations described. System 100 can include memory 106 for storing computer executable components and instructions. A processor 104 can facilitate operation of the computer executable components and instructions by system 100.

As will be appreciated by those of ordinary skill in the art, processor 104 can be included in any industrial, commercial, and/or consumer machinery with embedded, affiliated, associated and/or encapsulated processors such as industrial automation devices, computing devices (e.g., laptops, notebook computers, Personal Digital Assistants (PDAs), . . . ), cell phones, telephony equipment and/or devices, household and/or commercial appliances, etc. Additionally and/or alternatively, processor 104 can have associated storage, memory etc.

In accordance with an aspect, system 100 can include sentinel component 102, processor 104, memory 106, and storage component 108. Sentinel component 102 can be in communication with processor 104 for facilitating operation of computer executable instructions and components by system 100, memory 106 for storing computer executable components and instructions, and storage 108 for providing longer-term storage of data and/or computer executable components and instructions. Additionally, system 100 can receive input from various external devices and dispatch output to various external devices (e.g., other mobile devices, peripheral equipment that can be in correspondence and/or communicatively coupled with system 100). As will be appreciated by those of ordinary skill in the art, output can be dispatched in response to received input, or can be dispatched independently of received input.

Sentinel component 102 can be a component that intercepts calls to/from one or more application resident, operational, and/or executing on a device or system (e.g., system 100). Sentinel component 102 can also be a component that intervenes such that calls or requests to/from one or more applications resident, operational and/or executing on the device or system are interceded by sentinel component 102 for analysis and/or processing. The calls to/from the one or more applications can be calls or requests for access to one or more actions, functions, resources, or operations to be performed on, performed with, or performed by, system 100, for instance. Example actions, functions, resources, or operations that can be the subject of calls to/from the applications can be calls or requests for privileged access, requests for resources such as additional processing, memory or storage resources, requests for access to functions associated with protected operating system kernel and/or operating system resources that require super user or root access (e.g. privileged access) and/or administrator privileges, and the like. Additionally and/or alternatively, the call or request to/from the applications can be for access to protected and/or privileged data, such as bank account information, personal information (e.g., social security/benefits information, credit card account numbers, debit card account numbers, personal identification numbers (PINs), and the like), wherein such protected and/or privileged information can have been persisted to storage component 108, thereby utilizing storage component 108 (or a portion thereof) as a secure repository of protected and/or privileged information. As will be appreciated by those of ordinary skill, calls or requests to/from the application can also be for access to protected and/or privileged data that is situated in the cloud, wherein information, such as a username/password combination that can have been persisted in a protected area associated with storage component 108, can be employed to access privileged or protected information that can have been persisted to the cloud.

As a function of and/or in response to receipt, by sentinel component 102, of a call or request for an action, function, or operation to be performed by, or performed on, system 100, by applications operational and/or executing on system 100, sentinel component 102 can submit a request to an antiviral component requesting that the antiviral component supply or respond with a report that indicates the status of the implementation of the antivirus component that is resident, operational, and/or executing on system 100. Typically, an antiviral component is utilized to prevent, detect, and/or remove malware, such as computer viruses, key loggers, backdoors, toolkits, Trojan horses, worms, adware, spyware, and the like. Such an antiviral component can employ a number of strategies, such as signature-based detection which involves searching for unknown patterns of data within code or data.

If, after a defined period of time, sentinel component 102 has not received a response from the antiviral component, sentinel component 102 can notify the calling or requesting application that the functionalities and facilities associated with system 100 and/or its associated applications and/or components and/or persisted data may have become compromised, and thereafter can offer to continue to try soliciting a response from the antiviral component. Additionally and/or alternatively, sentinel component 102 can provide indications to the calling or requesting application that should the calling or requesting application wish to continue processing it can do so but on the clear understanding and/or acknowledgment that the calling or requesting application is fully cognizant of the risks and vulnerabilities of such continued processing. In this instance a record can be entered or recorded into a running log (e.g., error log, fault log, transaction log, etc.) noting the calling or requesting application's persistence in following through with continued processing despite being notified of the dangers associated with such an action.

If, within the defined window of time, a response in the form of a report or status report is received from the antiviral component, stating that the antiviral component has not been updated or has not been operational for a specified period of time (e.g., two weeks), sentinel component 102 can notify the calling or requesting application of these deficiencies noted in the status report and/or further notify the calling or requesting application that continuing with the processing of the call or request could possibly place system 100 in a hazardous state or can be considered to place system 100 at serious jeopardy of attack by malware, malicious exploits, and the like. Once again a log entry can be made into a running log associated with sentinel component 102, for example. Additionally and/or alternatively, the calling or requesting application, as a function of the status report obtained by (or through the aegis of) sentinel component 102 and taking heed of the warnings included in the status report, can be placed in stasis to be revived or reactivated at a later time and/or terminated. Notice of the calling or requesting application being placed into a hiatus state in response to the status report can also be placed into the log associated with sentinel component 102.

Where the calling or requesting application is placed in a state of stasis or a sleep state, on reactivation, the call or request from the calling or requesting application can once again be intercepted by sentinel component 102 at which time sentinel component 102, while recording the reactivation of the calling or requesting application, can request the antiviral component forward a status report which once again can be employed to assess whether or not the functionalities and facilities associated with system 100 and/or its resident, operational, and/or executing applications, and/or persisted data have become compromised or will place system 100 in jeopardy of malware attack. Similarly, in the situation where the calling or requesting application had previously been terminated but has now subsequently been restarted, the call or request from the restarted requesting application can once again be intercepted by sentinel component 102. Sentinel component 102 can then request an antiviral component to respond with a status report detailing the security status of system 100, its associated applications and/or persisted data, and the operability of their related functionalities and/or facilities. As elucidated above, the status report can be employed to determine whether or not the calling application should continue or persist with processing of the call or requests for continued operation, additional resources, and/or further access to privileged and/or protected resources and/or data.

In the situation where the calling or requesting application persists with processing the call or request for continued operations, additional resources, and/or further access to privileged and/or protected resources and/or data despite and/or regardless of sentinel component 102 providing indications that continuing with the call or request could place system 100 in serious jeopardy, sentinel component 102 can dispatch a notification to a remotely situated antiviral/antivirus update server to inform the remotely located antiviral/antivirus update server that the application (e.g., the calling or requesting application), despite having being informed of the risks associated with continued processing had nonetheless continued or persisted with the processing associated with the call or request. When this situation occurs, the next time that the calling or requesting application commences operation, sentinel component 102 on intercepting or detecting requests or calls emanating from the calling or requesting application can surreptitiously request that the antiviral component once again forward a status report which can be employed to ascertain whether or not the functionalities and/or facilities associated with system 100 and/or its resident, operational, and/or executing applications, and/or persisted data have been placed in a state of jeopardy by malware or other malicious exploits. It should be noted in this regard that where the calling or requesting application continues processing despite the warnings provided by sentinel component 102, sentinel component 102 can submit a request for a status report to the antiviral component without necessarily informing the calling or requesting application that it is submitting the request.

In the instance where, as a function of a status report being returned by an antiviral component to sentinel component 102 that indicates that system 100 and its affiliated resident, operational, executing applications, and/or persisted data have not been contaminated by malicious exploits or malware or have not been placed in jeopardy of malware attack, sentinel component 102 can send a notification that there is no prohibition on the calling or requesting application proceeding with the processing of the call or request for continued operation, additional resources, and/or access to privileged and/or protected resources and/or data. At this juncture, the calling or requesting application can forward a report to an antiviral/antivirus update server notifying the antiviral/antivirus update server that there were no impediments to processing the call or request for continued operation, additional resources, and/or access to privileged and/or protected resources and/or data, and that the processing culminated with a fruitful and successful conclusion.

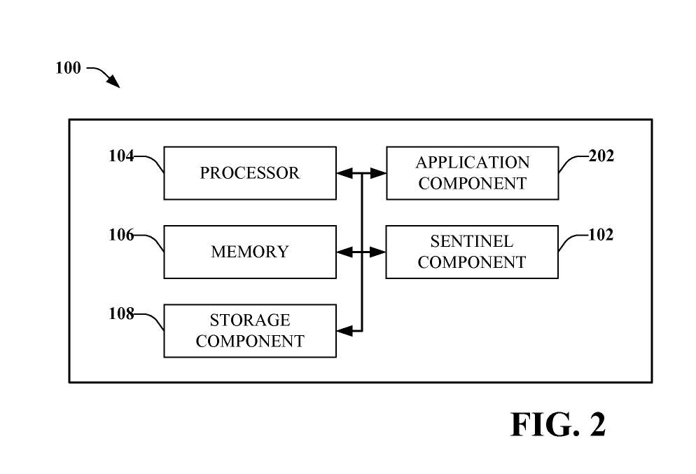

FIG. 2 provides a further non-limiting illustration of system 100, wherein system 100 includes application component 202 in addition to previously outlined sentinel component 102, processor 104, memory 106, and storage component 108. Application component 202 can operate in conjunction or collaboration with sentinel component 102. In this regard application component 202 can generate calls and/or requests for resource and/or access fulfillment, and/or action, function, or operation completion by system 100, for example. Illustrative and/or sample resource and/or access fulfillment and/or action, function, or operation calls or requests for completion by system 100 can include requests or calls for privileged access, requests for resources such as additional processing, memory, or storage resources, requests for access to functions associated with protected operating system kernel and/or operating system resources that can require super user or root access and/or administrator privileges, and the like. Additionally and/or alternatively, the generated calls or requests from application component 202 can be calls or requests for access to protected and/or privileged data, such as bank account information, personal information, social security benefits information, credit card account numbers, debit card account numbers, personal identification numbers, etc., wherein such protected and/or privileged information can have been persisted or stored to storage component 108. As has been noted above, the calls or requests generated by application component 202 can also be for access to protected and/or privileged data that can be situated remotely, for example in the cloud, wherein the solicited information, such as a username/password combination can be utilized by the application component 202 to access privileged and/so protected information that can have been remotely persisted, in the cloud for example.

As noted above, sentinel component 102 intercepts the calls or requests generated by application component 202 and as a function of such interception, sentinel component 102 directs a request for a status report to be returned from an antiviral component. Typically, the returned status report will indicate the status of the implementation of the antivirus component that can be resident, operational, and/or executing on system 100. Generally, the antiviral or antivirus component can be employed to prevent, detect, and/or remove malware, such as key loggers, backdoors, Trojan horses, worms, spyware, and the like. The antiviral or antivirus component, as noted earlier, can utilize a number of strategies, such as signature-based detection which can involve searching for unknown patterns of data within code or data (such as persisted documents and/or files).

Where, after a defined or definable period of time, sentinel component 102 has not received a response from the antiviral or antivirus component, sentinel component 102 can notify application component 202 that the functionalities and facilities associated with system 100 and/or its associated applications and/or components and/or persisted data can have become compromised. At this juncture, sentinel component 102 can provide indications to application component 202 that should application component 202 wish to continue processing its requests or calls it can do so, but only on a clear understanding and/or acknowledgment by application component 202 that continued processing of the call or request could potentially place system 100 in a potentially nonfunctional state. Additionally and/or alternatively, sentinel component 102 in recognition that a lack of response from the antiviral or antivirus component could be consequent upon one or more latencies (e.g., processing latencies, network latencies, etc.) can inform application component 202 that it will continue in its attempts to solicit a response from the antiviral or antivirus component, and that in the mean while application component 202 should, for example, enter a sleep state for a finite duration of time and/or until sentinel component 102 has been able to establish communication with the antiviral or antivirus component and/or has received a status report from the antiviral or antivirus component.

Thus, application component 202 can initially wait for a response or indication from sentinel component 102 as to whether or not application component 202 should continue processing the call or request that has been or was generated application component 202. Where application component 202 receives an indication or prompt from sentinel component 102 that it (e.g., application component 202) has an option to continue with or pursue processing the call or request but with an understanding and/or acknowledgment that continued processing of the generated call or request could have a deleterious effect on system 100, application component 202 can make an assessment as to the importance of the continued processing of the call or request. Such a determination as to the relative importance of continuing with the processing of the caller request can be made using a determination technology, such as artificial intelligence, neural networking, and/or collaborative filtering techniques, for instance. Where application component 202, using one or more determination methodologies or techniques, decides that the importance of continuing with the processing of the call or requests outweighs the importance of terminating the processing of the call or request to prevent damage to system 100, application component 202 can perform the further processing associated with the call on the request in full knowledge that such further processing could damage or place system 100 in a vulnerable or precarious state (e.g., open to malicious attacks by malware, spyware, adware, . . . ).

In the situation where, within a defined window of time, sentinel component 102 receives a response from the antiviral or antivirus component in the form of a status report, wherein the status report states that the antiviral or antivirus component has not been updated or has not been operational for a duration of time (e.g., two weeks), application component 202 can receive from sentinel component 102 a notification that, as a function of the status report received from the antiviral or antivirus component, continuing with the processing of the generated call or request could possibly place system 100 into a potentially hazardous state (e.g. in jeopardy of attack by malware, malicious exploits, and the like). Where application component 202 receives such notification from sentinel component 102, application component 202 can perform an analysis or an assessment to determine or ascertain whether or not it should proceed with processing the call or request. As noted above, an analysis or an assessment as to whether or not application component 202 should continue with the processing of the call or request can be accomplished using one or more ascertainment techniques, such as, cost benefit analysis, artificial intelligence methods, neural networks, collaborative filtering, Bayesian belief networks, and the like. As a consequence of the foregoing analysis or assessment as to whether or not application component 202 should continue with the processing of the call or request, application component 202 can terminate processing (e.g., stop executing), place itself into a state of stasis (e.g., put itself to sleep for a period of time), or it can carry on with processing of the call or request in the full knowledge that such actions can place the integrity of overall system (e.g., system 100) at risk of compromise by malicious software attack.

In the situation where application component 202 places itself in hiatus (e.g., a sleep state, a pause state, etc.), on reactivation application component 202 can re-generate the call or request which once again can be intercepted by sentinel component 102. As noted earlier, sentinel component 102 on intercepting the re-generated call or request from an application component (e.g., application component 202) can once again generate and/or direct a request for a status report from an antivirus or antiviral component. Where the antivirus or antiviral component fulfils the request by responding with a status report, the returned status report can be used to assess whether or not the facilities and/or functionalities associated with system 100 (and its affiliated applications, data, and/or devices) have become susceptible to attack or compromise by one or more malicious exploits. In a similar vein, where the soliciting application component 202 decides to terminate itself rather than opting to place system 100 at risk of attack, on restart or reactivation of the soliciting application component 202, calls or requests generated by the soliciting application component 202 can be intercepted by sentinel component 102 and thereafter sentinel component 102 can request an antiviral or antivirus component to respond with a status report that outlines the current security status of system 100, the security status of associated applications and/or persisted data, and the operability of system 100 and its affiliated applications and/or stored data. Once again the status report can be used to assess whether or not it is prudent to continue with the processing of the call or request for continued operation, additional resources, and/or access to privileged and/or protected resources and/or data.

As has been noted above, where application component 202 persists with processing the call or request for continued operation, further resources, and/or access to privileged and/or protected resources and/or data regardless of sentinel component 102 indicating the continuing with the call or request can place system 100 in jeopardy, sentinel component 102 can notify a remotely located antiviral/antivirus update server that application component 202 has continued with the processing associated with the call or request. In this instance, the next time that application component 202 commences operation and/or makes a call or request for resources, access to privileged and/or protected resources and/or data, or continued operation, sentinel component 102 can surreptitiously intervene requesting that an antiviral or antivirus component forward a status report that can be utilized to ascertain whether or not the facilities and/or functionalities associated with system 100 and/or its resident, operational, and/or executing applications, and/or data (persisted or active) have been jeopardized by malware or other malicious exploits.

Where application component 202 receives notification from sentinel component 102 that the applications, resident, operational, and/or executing on system 100, and/or active or persisted data associated with system 100 have not been compromised by malware, application component 202 can forward a report to an antiviral/antivirus update server informing the antivirus/antivirus update server that there were no impediments to processing the calls or requests necessary for continued operation, additional resources, and/or access to protected and/or privileged resources and/or data.

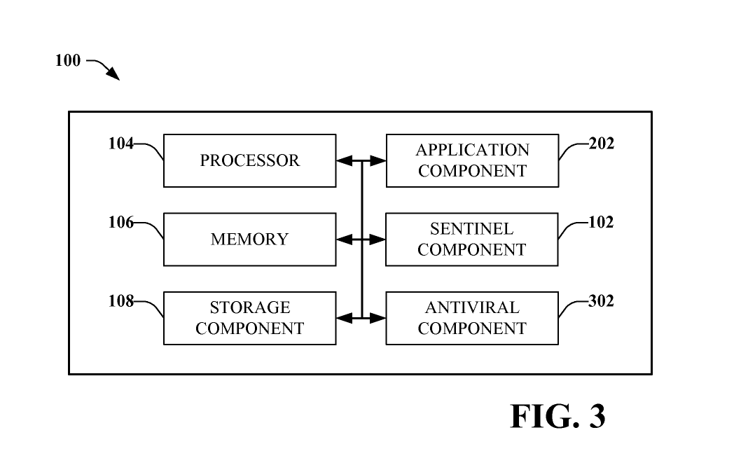

FIG. 3 provides a further non-limiting illustration of system 100, wherein system 100 includes antiviral component 302 in addition to previously detailed sentinel component 102, processor 104, memory 106, storage component 108, and application component 202. Antiviral component 302 can operate in collaboration with sentinel component 102 and an antivirus/antiviral update server. Antiviral component 302 can be communicatively or operably coupled to the antivirus/antiviral update server over a wired or wireless communication network, such as the Internet, intranet, wide area network, campus area network, metropolitan area network, local area network, and the like, wherein the Internet, intranet, wide area network, campus area network, metropolitan area network, local area network, can have aspects that utilize wired modalities, other aspects that utilize wireless modalities, and still yet other aspects that employ both wired and/or wireless modalities.

As noted above antiviral component 302 can be in continuous, periodic, intermittent, or sporadic communication with sentinel component 102, such that when sentinel component 102 intercepts calls to/from application component 202 resident, operational, and/or executing on system 100, antiviral component 302 can receive a request dispatched from sentinel component 102. On receipt of a request from sentinel component 102, antiviral component 302 can supply or respond with a report that indicates the current or present status of the implementation of antivirus component 302 resident, operational, and/or executing on system 100. As has been indicated above, antiviral component 302 is generally utilized to prevent, detect, and/or remove malware, such as computer viruses, key loggers, backdoors, toolkits, Trojan horses, worms, adware, spyware, and the like. Accordingly, antiviral component 302 can employ a number of strategies, such as signature-based detection which involves searching for unknown patterns of data within code or data in order to facilitate and/or achieve its aims.

In accordance with an embodiment, antiviral component 302 can respond to the request from sentinel component 102 with, for instance, a status report detailing the fact that antiviral component 302 has not been updated or has not been operational for a specified period of time. At this juncture, sentinel component 102 can notify the calling or requesting application (e.g., application component 202) of these deficiencies and can further notify calling or requesting application component 202 that continuing with the processing of the call or request could possibly place system 100 in a hazardous state or can be considered to place system 100 at serious jeopardy of attack by malware, malicious exploits, and the like. A log entry can be made into a running or transactional log associated with sentinel component 102, application component 202, and/or antiviral component 302, for example. Additionally and/or alternatively, calling or requesting application component 202, as a function of the status report obtained by sentinel component 102 and taking heed of the warnings included in the status report, can either place itself into a state stasis and revive or reactivate itself at a later time and/or application component 202 can terminate. Notice of calling or requesting application 202 being placed into a hiatus state or a terminate state in response to the status report can also be noted in the log associated with sentinel component 102, application component 202, and/or antiviral component 302.

As stated above, where application component 202 is placed in a hiatus or a sleep state, on reawakening, the call or request from application component 202 can once again be intercepted by sentinel component 102 at which point sentinel component 102, while noting the reactivation of the calling or requesting application component 202, can once again request antiviral component 302 to forward a status report with which to assess whether or not the functionalities and facilities associated with system 100 and/or its resident, operational, and/or executing applications, and/or persisted data have become compromised or will place system 100 in jeopardy of malware attack. Similarly, in situations where the calling or requesting application 202 had previously been terminated but has now subsequently been restarted, the call or request from restarted application component 202 can be intercepted by sentinel component 102. Sentinel component 102 can then request an antiviral component 302 to respond with a status report detailing the security status of system 100, its associated applications and/or persisted data, and the operability of their related functionalities and/or facilities. The status report, as has been outlined above, can be employed to determine whether or not calling application component 202 should continue processing the call or request for continued operation, additional resources, and/or further access to privileged and/or protected resources and/or data. Once again note of the foregoing activities can be recorded in logs affiliated with sentinel component 102, application component 202, and/or antiviral component 302.

In instances where, as a function of the status report returned by antiviral component 302 to sentinel component 102 indicates that system 100 and its affiliated resident, operational, executing applications, and/or persisted data have not been contaminated by malicious exploits or malware or have not been placed in jeopardy of malware attack, sentinel component 102 can send a notification that there is no prohibition on the calling or requesting application component 202 proceeding with the processing of the call or request for continued operation, additional resources, and/or access to privileged and/or protected resources and/or data. At this juncture, calling or requesting application component 202 can forward a report to an antiviral/antivirus update server notifying the antiviral/antivirus update server that there were no impediments to processing the call or request for continued operation, additional resources, and/or access to privileged and/or protected resources and/or data, and that the processing culminated with a fruitful and successful conclusion. Additionally, a record of such activity can be made to logs associated with sentinel component 102, application component 202, antiviral component 302, and/or logs associated with the antiviral/antivirus update server.

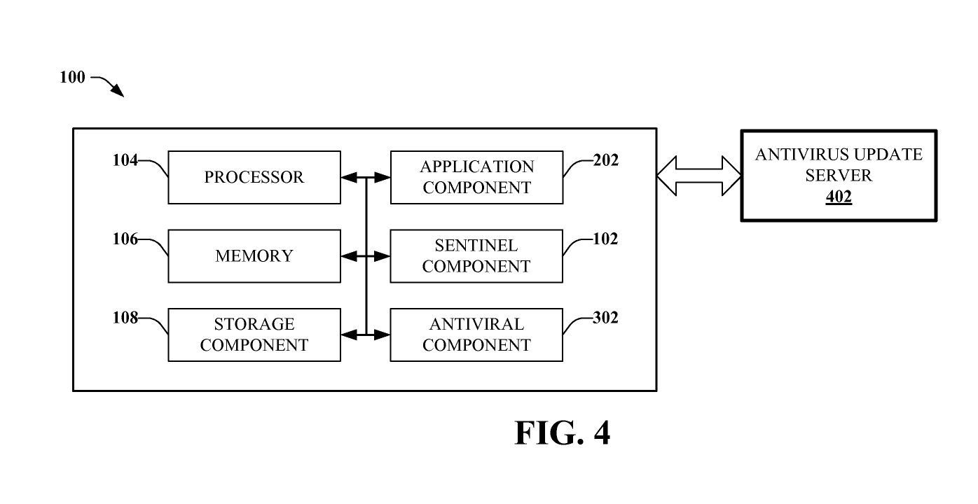

FIG. 4 provides another non-limiting depiction of system 100, wherein system 100 includes antivirus update server 402 in addition to sentinel component 102, processor 104, memory 106, storage component 108, application component 202, and antiviral component 302. As depicted, antivirus/antiviral update server 402 can be remotely located from system 100. Thus, antivirus/antiviral update server 402 can be in communication with system 100 over a wired and/or wireless network. Examples of such a wired and/or wireless networks can include wireless communication networks, a wired communication networks, an Internet, an intranet, local area networks, a metropolitan area networks, a campus area networks, wide area networks, networks that include both wired modalities and/or wireless modalities, wherein the wireless modalities can include utilization of satellite technologies.

As noted earlier, antivirus/antiviral update server 402 can be utilized in situations where a calling or requesting application component 202 persists with the processing of the call or request for additional operations, resources, and/or access to privileged and/or protected resources and/or data, regardless of indications from sentinel component 102 stating that continued processing with the call or request could possibly place system 100 in jeopardy of imminent malfunction. At this point, sentinel component 102 can dispatch a notification to antivirus/antiviral update server 402 informing the antiviral/antivirus update server 402 that application component 202, despite having being amply informed and warned of the risks associated with continued processing has nevertheless continued or persisted with the processing associated with the call or request. Thus, antivirus/antiviral update server 402 can receive a notification from sentinel component 102 that application component 202 has continued with the processing associated with a call or request despite having been notified by sentinel component 202 that such an action could possibly be deleterious to system 100. On receiving such a notification from sentinel component 102, antivirus/antiviral update server 402 can record the notification in one or more transactional logs associated with antivirus/antiviral update server 402.

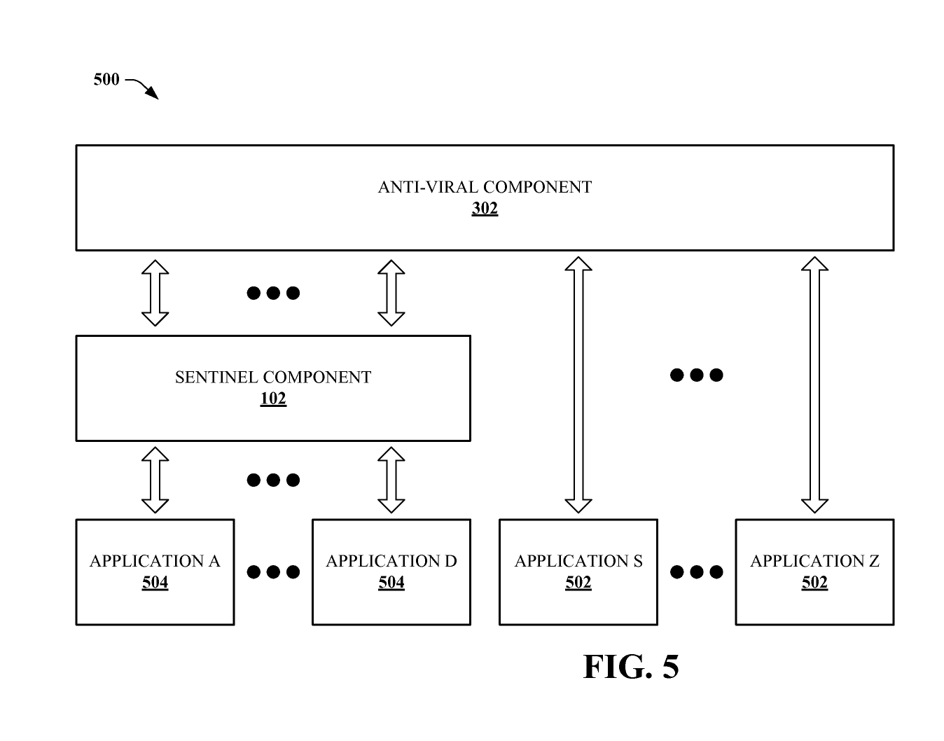

FIG. 5 illustrates instances where application component 502 (e.g., application S . . . application Z, where S and Z are integers greater than or equal to zero) has sufficient capability to conduct interactions with antiviral component 302 without the necessity for sentinel component 102 to intercept calls or requests to ensure that system 100 is not compromised. In this instance, application component 502 (e.g., application S . . . application Z) can have been imbued with sufficient intelligence (e.g., provided by artificial intelligence aspects, collaborative filtering aspects, probabilistic based aspects, etc. (not shown)) to ascertain from status reports directly supplied by antiviral component 302 whether or not continued operation associated with processing a call or request could possibly place system 100 at serious risk of attack or harm from malware. In these situations where application component 502 (e.g., application S . . . application Z) can maintain a direct dialog with antiviral component 302 in order to solicit status reports prior to making calls or requests for additional resources, etc., the functionalities and facilities provided by sentinel component 102 may be obviated or prove to be unnecessary.

It should be noted, FIG. 5 also illustrates other application components 504 (e.g., application A . . . application D, where A and D are integers greater than or equal to zero) that, as described above, must utilize the features, functionalities, and facilities provided by sentinel component 102, due to the fact that these application components 504 (e.g., application A . . . application D), for various reasons (e.g., implementations of obsolete technologies, . . . ) are incapable of direct communication with antiviral component 302, and thus are incapable of requesting status reports regarding system 100 upon which to base determinations as to whether or not continued processing of prospective calls or requests for further operations and/or resource should be carried on.

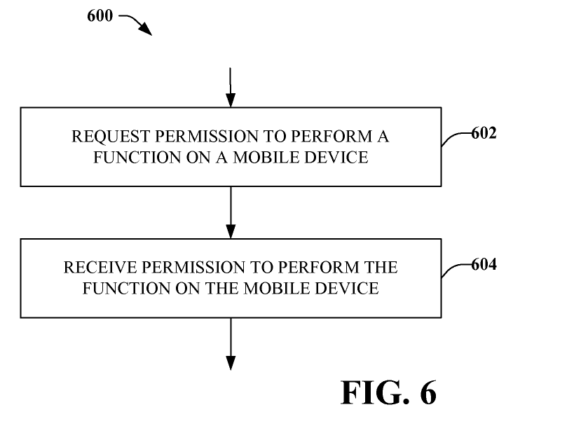

FIGS. 6-8 illustrate processes in connection with the aforementioned systems. The processes in FIGS. 6-8 can be implemented for example by system 100 illustrated in FIGS. 1-4 respectively. Additionally, it should be appreciated that the methods disclosed in this specification are capable of being stored as computer-executable instructions on a non-transitory computer readable medium that in response to execution, cause a system including at least one processor to perform operations in accordance with the methods.

FIG. 6 illustrates an example methodology 600 that can be utilized by an application (e.g. application component 202) operational or executing on system 100. The methodology outlined as method 600 can commence at 602 whereupon the application (e.g., application component 202) can request permission to perform a function on a mobile device. As noted above, functions that can be performed on a mobile device (e.g., system 100) can include requests to perform further operations, requests for further resources, requests to access protected and/or privileged data and/or resources (e.g., resources associated with the operating system kernel), and the like. Typically, where application component 202 is incapable of direct communication with an antiviral component 302, such calls emanating from application component 202 can be intercepted by a sentinel component 102. Sentinel component 102 can thereafter perform operations as has been described above. Where application component 202 is capable of direct communication with an antiviral component 302, application component 202 can direct a request to the antiviral component 302 that the antiviral component 302 respond with a status report upon which the application component 202 can base a decision as to whether or not a prospective call or request for further resources, access to protected and/or privileged data and/or resources, or for continued operations will place system 100 in jeopardy of attack by malicious software, such as malware, adware, spyware, . . . .

At 604 application component 202 can receive permission to perform the function on the mobile device. Alternatively, when no status report is received from an antiviral component 302, either directly from antiviral component 302 or indirectly through the features, functionalities and/or facilities provided by sentinel component 102 (e.g., sentinel component 102 does not supply indications that application component 202 can continue with the processing contained in requests or calls that emanated from application component 202), application component 202 can place itself into a state of stasis to await reactivation at a later time or application component 202 can terminate itself. As has been noted above, where application component 202 receives indications from sentinel component 202 that it (e.g., application component 202) has an option as to whether or not to continue with the processing contained in the requests or calls that can have been intercepted by sentinel component 102, for example, application component 202 can opt to place itself in a hibernation state for a period of time (e.g., a fixed or randomly selected period of time), decide to carry on with the processing necessary to fulfill the request or call, or decide the continued operations pose too much of a risk to system 100.

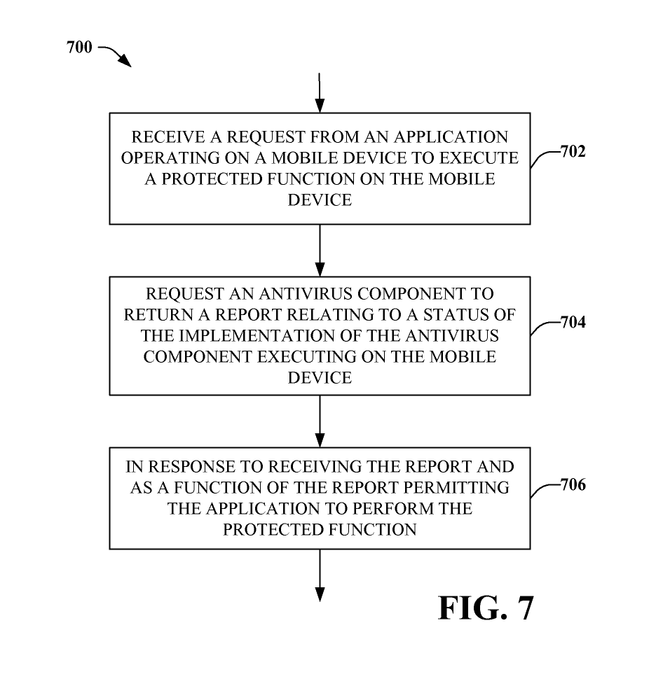

FIG. 7 depicts an example methodology 700 functional on sentinel component 102, for instance. Method 700 can commence at 702 where a request from an application (e.g., application component 202) operational, operating, and/or executing on a mobile device (e.g. system 100) can be intercepted by sentinel component 102, for example. The intercepted request can be for access by the application (e.g., application component 202) to resources, such as, privileged and/or protected data, access to protected and/or privileged aspects associated with the operating system, utilization of protected and/or privileged communication resources, continued operation, and the like, associated with the mobile device (e.g., system 100). At 704 a request can be dispatched by sentinel component 102 to an antivirus component (e.g. antivirus component 302) requesting that the antivirus component (e.g., antivirus component 302) return a report that relates the status of the implementation of the antivirus component (e.g., antivirus component 302) that can be operational, operating, and/or executing on the mobile device (e.g., system 100). At 706, sentinel component 102 having received a response from the antivirus component (e.g., antivirus component 302) within a defined or definable period of time can, as a function of the report, can dispatch to the application (e.g., application component 202) permission to carry on processing the intercepted call or request for resources. Additionally and/or alternatively, at 706 sentinel component 102, as has been described above, can indicate to the requesting or calling application, whose request or call for resources sentinel component 102 has intercepted, that as a consequence of or in response to (or in response to the lack of response of from the antivirus component) the received report from an antivirus component (e.g., antivirus component 302) that further processing of the request or call might compromise operation of system 100.

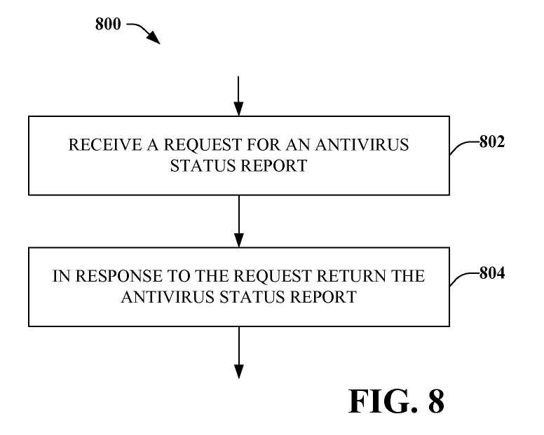

FIG. 8 illustrates a further example method 800 that can be operational or executing on antivirus component 302, for example. Method 800 can commence at 802 where antivirus component 302, operating in conjunction with processor 104, memory 106, and/or storage component 108, can receive from sentinel component 102 (also operating in collaboration with processor 104, memory 106, and/or storage component 108) a request that antivirus component 302 return a status report that indicates the current or prevail status of the implementation of antivirus component 302, the current status of system 100 and its associated applications and/or persisted data, and/or the operability and functionality of antivirus component 302 and/or system 100. At 804 antivirus component 302 (in cooperation with processor 104, memory 106, and/or storage component 108) in response to the request received from sentinel component 102 can return the status report back to sentinel component 102.

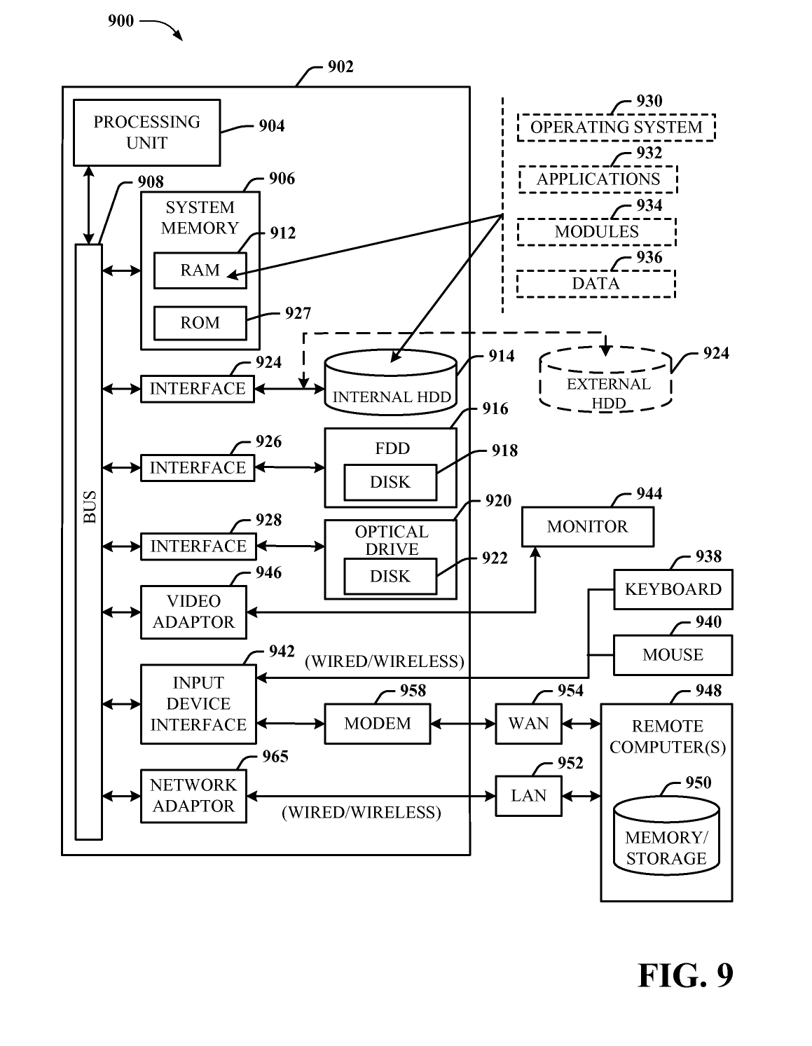

With reference to FIG. 9, an exemplary environment 900 for implementing various aspects described herein includes a computer 902, the computer 902 including a processing unit 904, a system memory 906 and a system bus 908. The system bus 908 connects system components including, but not limited to, the system memory 906 to the processing unit 904. The processing unit 904 can be any of various commercially available processors. Dual microprocessors and other multi processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 can also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 911 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that aspects of the subject disclosure can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 can operate in a networked environment using logical connections by wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or can be connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi® and Bluetooth™ wireless technologies. Thus, the communication can be a predefined structure as with a conventional network or simply an ad hoc communication between at least two devices.

Wi-Fi, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), or other bands (e.g., 802.11g, 802.11n, . . . ) so the networks can provide real-world performance similar to the basic 10BaseT wired Ethernet networks used in many offices.

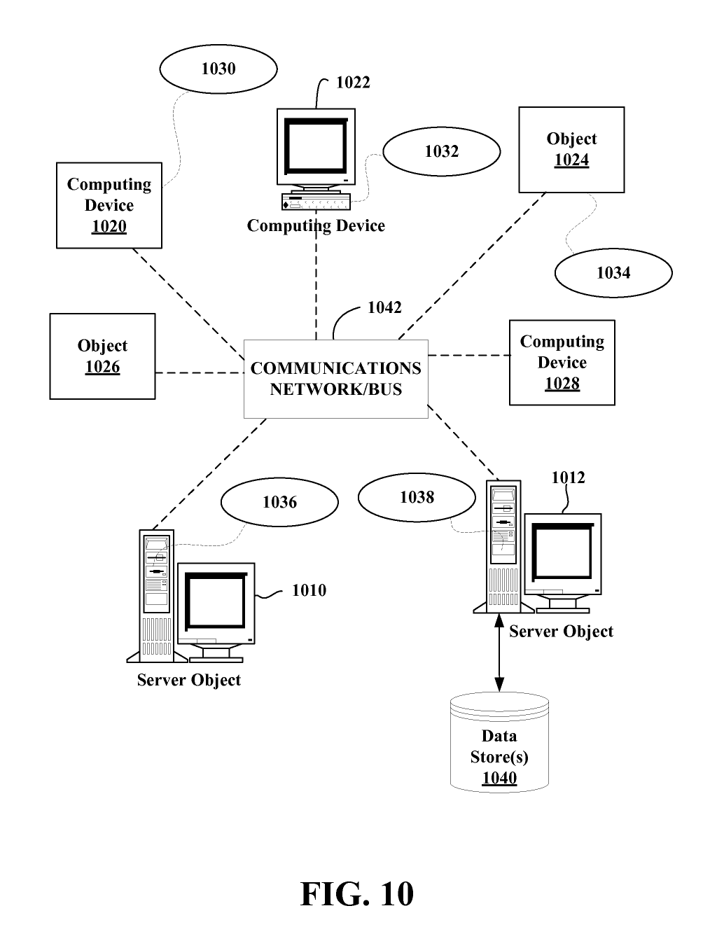

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices or similar devices depicted within the illustrations, or other devices such as a mobile phone, personal digital assistant (PDA), audio/video device, MP3 players, personal computer, laptop, etc. It should be further appreciated that data store(s) 1040 can include storage component 108, or other similar data stores disclosed herein.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques for rating and weighting the ratings of online content in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for rating and weighting the ratings of online content as described in various embodiments herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service, in some cases without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

Reference throughout this specification to “one embodiment,” “an embodiment,” “a disclosed aspect,” or “an aspect” means that a particular feature, structure, or characteristic described in connection with the embodiment or aspect is included in at least one embodiment or aspect of the present disclosure. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in various disclosed embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The subject matter described herein can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary,” “demonstrative,” or the like, is not necessarily to be construed as preferred or advantageous over other aspects or designs, nor is it meant to preclude equivalent exemplary structures and techniques known to those of ordinary skill in the art.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A system, comprising:
a memory to store instructions; and
a processor, communicatively coupled to the memory, that facilitates execution of the instructions to perform operations, comprising:
receiving, from an application that is executing on a mobile device, a request to perform a function controlled by an operating system executing on the mobile device;
sending a status request to an antiviral application executing on the mobile device in response to receiving the request;
receiving an antiviral status report associated with the mobile device in response to sending the status request to the antiviral application; and
forwarding the antiviral status report to the application, wherein the antiviral status report is employed by the application to perform the function on the mobile device.

2. The system of claim 1, wherein the antiviral status report grants the application permission to perform the function on the mobile device.

3. The system of claim 1, wherein the antiviral status report denies the application permission to perform the function on the mobile device.

4. The system of claim 1, wherein the function controlled by the operating system includes a grant for access to a protected kernel resource associated with the operating system.

5. The system of claim 1, wherein the function controlled by the operating system includes a grant for access to a data resource remotely accessed via a communication port controlled by the operating system.

6. The system of claim 1, wherein the function controlled by the operating system is a request by the application for a further operation.

7. The system of claim 1, wherein the operations further comprise, in response to failing to obtain the antiviral status report within a defined duration of time, notifying the application to perform the function and recording an entry into a transactional log noting performance of the function by the application.

8. A method, comprising:
in response to receiving a request to perform an operation from an application under control of an operating system executing on a mobile device comprising a processor, sending a status request to an antiviral application executing on the mobile device; and
as a function of receiving a status report within a defined period of time from the antiviral application in response to the status request, notifying the application of a permission to perform the operation on the mobile device.

9. The method of claim 9, further comprising accessing, by the application, a data resource located remotely from the mobile device as a function of the permission.

10. The method of claim 9, further comprising accessing, by the application, a kernel operation associated with the operating system as a function of the permission.

11. The method of claim 9, further comprising directing, by the application, a request for data to a database via a communication port controlled by the operating system as a function of the permission.

12. The method of claim 9, wherein the notifying further comprises, in response to failing to receive the status report within the defined period of time, notifying the application to perform the operation and to record an entry into a log that identifies the application as having performed the operation.

13. The method of claim 9, wherein the notifying further comprises, in response to failing to receive the status report within the defined period of time, notifying the application to desist from performing the operation and to record an entry into a log that identifies the application as having desisted performance of the operation.

14. The method of claim 9, wherein the notifying further comprises, in response to failing to receive the status report within the defined period of time, notifying the application to enter a sleep state for a defined back off period prior to resend the request on an expiration of the defined back off period.

15. The method of claim 9, wherein the notifying further comprises, in response to failing to receive the status report within the defined period of time, notifying the application to cease operation and to record a failure to perform the operation in a log entry.

16. A tangible computer readable medium comprising instructions that, in response to execution, cause a computing system including a processor to perform operations, comprising:
receiving a status report from a control component within a defined time period in response to directing a status request, by an activation component, to the control component; and
forwarding the status report to the activation component that performs an action on a mobile device as a function of the status report.

17. The tangible computer readable medium of claim 16, wherein the operations further comprise, in response to not receiving the status report within the defined time period, forwarding a permission to the activation component to perform the action on the mobile device and to record indication of the forwarding of the permission to a transactional log.

18. The tangible computer readable medium of claim 16, wherein the operations further comprise, in response to not receiving the status report within the defined time period, forwarding a request that the activation component enter a state of stasis for a randomly selected time period before redirecting the status request to the control component at an expiration of the randomly selected time period.

19. The tangible computer readable medium of claim 16, wherein the operations further comprise, as a function of not receiving the status report within the defined time period, forwarding a cease operations request to the activation component.

20. The tangible computer readable medium of claim 16, wherein the operations further comprise at a successful completion of the action on the mobile device notifying a remotely situated antivirus update server of the successful completion of the action.
